(19) United States
(12) Patent Application Publication
(10) Pub. No.: US 2005/0148420 A1
(43) Pub. Date: Jul. 7, 2005

(54) Autotensioner

(75) Inventor: Masayuki Murao, Hyogo (JP)

Correspondence Address: NIXON PEABODY, LLP, 401 9TH STREET, NW, SUITE 900, WASHINGTON, DC, 20004-2128, US

(73) Assignee: Bando Chemical Industries, Ltd., Kobe-shi (JP)

(21) Appl. No.: 11/022,992

(22) Filed: Dec. 28, 2004

(30) Foreign Application Priority Data
Jan. 5, 2004 (JP) 2004-000209

(51) Int. Cl. F16H 7/08; F16H 7/12; F16H 7/22

(52) U.S. Cl. 474/133; 474/135; 474/110; 474/109

(57) ABSTRACT

In an autotensioner 16 used in an auxiliary drive system A1 for a multicylinder engine 1 configured to suspend cylinder operation, a damper 24 is provided to suppress the vibration of an arm 18 by means of the viscous drag of a magnetorheological fluid (MRF). The damper 24 is provided with an electromagnet 34 which applies magnetic force to the MRF. When some of the cylinders in the running engine 1 are suspended from working, the electromagnet 34 of the damper 24 is excited in response to a signal from an engine controller 38 to apply the magnetic force to the MRF, thereby increasing the viscous drag of the MRF and suppressing the vibration of the arm 18 or a belt span 13a. In this manner, the vibration of the arm 16 of the tensioner 16 and the belt span 13a is suppressed to prevent the occurrence of an unusual sound and the loss of life of a belt 13.

### CROSS-REFERENCE TO RELATED APPLICATION

This non-provisional application claims priority under 35 U.S.C. §119(a) on Patent Application No. 2004-209 filed in Japan on Jan. 5, 2004, the entire contents of which are hereby incorporated by reference.

### BACKGROUND OF THE INVENTION

(a) Field of the Invention

The present invention relates to an autotensioner which automatically adjusts the tension of a belt in a belt drive system. In particular, it relates to an autotensioner which makes use of the viscous drag of a magnetorheological fluid to suppress the vibration of a moving member associated with a change in the belt tension.

(b) Description of Related Art

Autotensioners of this kind have conventionally been known. Depending on kind of dampers used, they are classified into hydraulic, frictional and viscous autotensioners. Hydraulic and viscous dampers allow damping by using the viscosity of oil and frictional dampers employ the frictional drag of a resin or metal.

For example, conventionally known hydraulic autotensioners which are generally used in an auxiliary drive system for a vehicle engine include arm-type hydraulic autotensioners and rod-type hydraulic autotensioners. The arm-type hydraulic autotensioner includes an arm whose proximal end is rotatably supported on a stationary member such as an engine side wall, a tension pulley which is rotatably supported on a distal end of the arm and on which a belt runs and a hydraulic damper which applies a damping force to the rotation of the arm.

The rod-type hydraulic autotensioner includes a rod member which is supported on a stationary member such as an engine side wall to be slidable in the axial direction, a tension pulley which is rotatably supported on a distal end of the rod member and a hydraulic damper connected to the rod member to damp the sliding movement of the rod member.

The hydraulic damper as described above includes a cylinder body, a piston which is reciprocatably fitted in the cylinder body to divide a cavity in the cylinder body into first and second chambers filled with oil and a rod which is connected to the piston to extend from and retract into the cylinder body. One of the cylinder body and the rod is connected to the stationary member and the other is connected to the arm or the rod member. The first and second chambers in the cylinder body communicate with each other via an oil path formed in the piston (or a clearance between the cylinder body and the piston). The oil path is provided with a check valve for preventing the oil in the second chamber from flowing to the first chamber. The second chamber is provided with a spring (biasing means) which biases the rod to extend from the cylinder body, whereby the belt is pressed by the tension pulley.

If the rod is extended by the biasing force of the spring, the oil flows from the first chamber to the second chamber without any influence of the check valve. Therefore, the rod extends smoothly and quickly to move the tension pulley toward pressing the belt. On the other hand, when the belt tension increases to retract the rod together with the tension pulley, the check valve prevents the oil in the second chamber from flowing to the first chamber via the oil path. The oil passes through a small clearance between the piston and the inner surface of the cylinder body to generate high viscous drag, thereby causing a damping effect.

That is, in order to absorb the change in the belt tension, it is necessary to apply damping force to the rod when the belt tension increases (when the rod retracts), or quickly respond to the change and apply the tension to the rod when the belt tension decreases (when the rod extends). The hydraulic damper described above is configured to meet this requirement.

There is another known rod-type hydraulic autotensioner in which the rod member serves as one of the cylinder body and the rod of the hydraulic damper and the stationary member serves as the other (see Japanese Unexamined Patent Publication No. HEI9-60697, for example).

Further, as disclosed by Japanese Unexamined Utility Model Publication No. SHO63-89457, for example, it has been proposed to replace the oil filling the cavity of the cylinder body of the hydraulic damper with a magnetorheological fluid. The magnetorheological fluid is made of extra-fine ferromagnetic material dispersed in liquid such as oil. The viscous drag of the magnetorheological fluid can be varied by applying a magnetic force to the magnetorheological fluid from outside.

In recent years, there has been practically used a technique that, when a multicylinder engine is running, suspends the operation of some cylinders by halting fuel supply to the cylinders and ignition therein and the operation of intake/exhaust valves of the cylinders (hereinafter the technique is referred to cylinder suspension or cylinder idling). Since some of the cylinders do not perform combustion and pumping, fuel consumption by the engine under the light load operation is drastically reduced.

However, in the auxiliary drive system and the valve operating system of the engine configured to idle the cylinders, the belt tension suddenly varies due to a change in output torque of the engine which occurs when the number of working cylinders is changed. In the valve operating system, in particular, suspending the operation of the intake/exhaust valves of the cylinders may possibly cause direct variation in the belt tension. However, the damper of the conventional autotensioner does not give a damping resistance which is high enough to prevent the vibration of the moving member of the tensioner caused by the sudden variation in the belt tension. Therefore, there is difficulty in suppressing the vibration of the tensioner with the damper. Accordingly, the moving member of the tensioner may vibrate to almost leap to cause an unusual noise such as clatter or decrease the belt life.

If the damping resistance of the damper is set high from the beginning, the vibration of the tensioner may be suppressed even if the belt tension suddenly varies due to the change in the number of the working cylinders in the engine. However, due to the increased damping resistance, the autotensioner almost becomes a fixed tensioner. Therefore, suitable belt tension cannot be given in the normal state and the belt may possibly slip on the pulley due to a lack of tension.

Under these circumstances, the inventor of the present invention has proposed another technique in his previous patent application (e.g., see the specification of Japanese Patent Application No. 2002-034996). According to the technique, the magnetorheological fluid is used in place of the oil in the autotensioner. Then, a magnetic force is applied to the magnetorheological fluid to raise the viscous drag when vibration of the tensioner or the belt exceeding a specified level is detected, thereby suppressing the vibration of the moving member.

According to the above proposition, the magnetic force is applied to the magnetorheological fluid in the vibration suppression mechanism when the vibration of the tensioner or the belt exceeds the specified level to increase the viscous drag, thereby suppressing the vibration of the moving member and the belt span. Accordingly, the vibration of the belt or the moving member due to the variation in the belt tension is suppressed to prevent a slip of the belt or the occurrence of an unusual noise such as clatter. Further, the belt life is prolonged.

However, for the above multicylinder engine which changes the number of the working cylinders during the operation and may cause a sudden variation in the belt tension due to a variation in the engine output, it has been required to provide a higher-response control over the autotensioner in the belt drive system than that in the proposed technique to adjust the belt tension without delay for the purpose of effective reduction of influence due to a variation in the belt tension.

### SUMMARY OF THE INVENTION

The present invention has been achieved in view of this requirement. The present invention is directed to an autotensioner including a vibration suppression mechanism which damps vibration of the moving member by means of the viscous drag thereof, and an object of the present invention is to eliminate vibration of the tension pulley and a leap of the moving member by applying a magnetic force to the magnetorheological fluid to increase the damping force of the vibration suppression mechanism by the viscous drag of the magnetorheological fluid before the tensioner and the belt actually vibrate. For that purpose, the inventor of the present invention has made the best use of inventiveness to establish the starting conditions for controlling the viscous drag of the magnetorheological fluid.

In respect of the autotensioner which makes use of the viscosity of oil to suppress the vibration of the moving member in the belt drive system for the multicylinder engine configured to suspend cylinder operation, the present invention has replaced the oil with the magnetorheological fluid. Further, according to the present invention, a magnetic force is applied to the magnetorheological fluid in the vibration suppression mechanism in response to a control signal which is given when the number of the working cylinders in the engine is changed. Thus, the above object is achieved.

More specifically, the invention according to claim 1 relates to an autotensioner comprising: a moving member which is movably supported on a stationary member; a tension pulley which is rotatably supported on the moving member and around which a belt is wrapped; a biasing means for biasing the moving member such that the tension pulley presses the belt; a vibration suppression mechanism which damps the vibration of the moving member by means of viscous drag of a magnetorheological fluid; and a magnetic force application device which applies a magnetic force to the magnetorheological fluid in the vibration suppression mechanism, wherein the autotensioner is configured to automatically adjust the tension of the belt used in a belt drive system for an engine, and when variation in the belt tension is more significant than specified, to allow the magnetic force application device to apply the magnetic force to the magnetorheological fluid in the vibration suppression mechanism to increase the damping force of the vibration suppression mechanism due to the viscous drag on the moving member.

Where the engine is a multicylinder engine provided with a cylinder suspension controller which suspends the operation of some cylinders in the engine in operation, the autotensioner further comprises a magnetic force controller which controls the magnetic force application device such that the magnetic force is applied to the magnetorheological fluid in the vibration suppression mechanism in response to a signal from the cylinder suspension controller which is given when the operation of the cylinders is suspended or the operation of the suspended cylinders is restarted by the cylinder suspension controller.

According to this configuration, when a decrease occurs in the tension of the belt running on the tension pulley in the autotensioner provided in the belt drive system for the multicylinder engine, the biasing means exerts a biasing force to move the moving member such that the tension pulley presses the belt. When the belt tension increases, the tension pulley is pressed by the belt to move the moving member against the biasing force exerted by the biasing means.

The vibration suppression mechanism of the autotensioner suppresses the vibration of the moving member by making use of the viscous drag of the magnetorheological fluid. When the cylinder suspension controller at least suspends the operation of some of the cylinders in the engine or restarts the operation of the suspended cylinders, the magnetic force controller controls the magnetic force application device in response to a signal from the cylinder suspension controller. Then, the magnetic force application device applies the magnetic force to the magnetorheological fluid in the vibration suppression mechanism to increase the viscous drag of the magnetorheological fluid. Therefore, even if the engine output suddenly varies due to the change in the number of the working cylinders, the vibration of the moving member (and the belt span) is suppressed.

In general, when the vibration state of the tensioner or the belt is detected by a sensor to apply the magnetic force to the magnetorheological fluid in the vibration suppression mechanism, a delay of the signal output from the sensor and a time lag from the application of the magnetic force to the magnetorheological fluid to the exertion of the damping force are inevitable. Therefore, although possible to alleviate, it is impossible to eliminate vibration of the tension pulley or a leap of the moving member. According to the present invention, however, the magnetic force is applied to the magnetorheological fluid in the vibration suppression mechanism, immediately before the actual vibration of the tensioner and the belt, based on the control signal for changing the number of the working cylinders in the engine, thereby increasing the damping force. Thus, a leap of the belt or the moving member associated with the suspension of the cylinders is eliminated to prevent a slip of the belt and the occurrence of an unusual noise such as clatter with higher reliability. Moreover, the belt life is prolonged.

The magnetorheological fluid (MRF) according to the present application is made of magnetic particles of about 0.5 to 50 μm particle size dispersed stably in a medium. The fluid is a colloid in which the particles easily gather to form clusters upon application of a magnetic field, thereby giving a high shear resistance. The magnetorheological fluid is completely different in the shear resistance against the magnetic field and applications thereof from a magnetic fluid which is made of magnetic particles of about 5 to 50 μm particle size dispersed in a medium and used for shaft sealing and the like.

In the invention according to claim 2, the magnetic force controller controls the magnetic force application device when the operation of the multicylinder engine is shifted from a full cylinder operation mode in which all of the cylinders are working to a partial cylinder operation mode in which not less than one third thereof are suspended from working. That is, when the engine operation is shifted from the full cylinder operation mode to the partial cylinder operation mode, the output torque of the engine varies significantly. Therefore, at this time, the magnetic force is applied to the magnetorheological fluid in the vibration suppression mechanism to increase the viscous drag (or the shear resistance) thereof. Thus, the vibration of the moving member (and the belt span) is suppressed in a more effective manner.

In the invention according to claim 3, the magnetic force controller controls the magnetic force application device such that the magnetic force is applied to the magnetorheological fluid in the vibration suppression mechanism in synchronization with the change in the number of the working cylinders. By so doing, the magnetic force application device is controlled at optimum timing without being ahead or behind of the variation in the engine output torque caused by the change in the number of the working cylinders.

In the above configuration, the magnetic force controller preferably controls the magnetic force application device such that the movement of the moving member is locked. By so doing, the vibration of the moving member and the belt span is surely stopped, thereby preventing the vibration of the belt and the moving member derived from the change in the number of the working cylinders in the engine.

The above-described belt drive system is preferably an auxiliary drive system which drives the auxiliaries by the engine via the belt, or a valve operating system which opens or closes at least one of intake/exhaust valves of the engine via the belt. The present invention is particularly effective in these belt drive systems.

The above-described vibration suppression mechanism preferably includes a cylinder body, a piston which is reciprocatably fitted in the cylinder body to divide a cavity in the cylinder body into two chambers filled with the magnetorheological fluid, a communication path communicating with both of the chambers in the cylinder body and a rod which is connected to the piston to extend from and retract into the cylinder body. It is also preferable that one of the cylinder body and the rod is connected to the stationary member and the other is connected to the moving member. In such a case, the magnetic force application device is preferably configured to apply the magnetic force to the magnetorheological fluid in the communication path.

With this configuration, when the tension pulley moves together with the moving member upon the variation in the belt tension, the movement of the moving member makes the piston reciprocate in the cylinder body. Then, the magnetorheological fluid moves to and from the two chambers in the cylinder body via the communication path, whereby the flow resistance of the magnetorheological fluid is varied by the change in the magnetic force to vary the damping force. Thus, a preferable vibration suppression mechanism using the magnetorheological fluid is obtained.

Further, the above-described vibration suppression mechanism may be the one including a fluid chamber which is arranged coaxially with the rotational axis of the moving member between the stationary member and the moving member and filled with the magnetorheological fluid. In the fluid chamber, at least one plate toward the stationary member which is arranged co-rotatably with the stationary member and at least one plate toward the moving member which is arranged co-rotatably with the moving member may be arranged alternately along the direction of the rotational axis of the moving member. In this case, the magnetic force application device is preferably configured to apply the magnetic force to the magnetorheological fluid in the fluid chamber.

With this configuration, when the tension pulley moves together with the moving member upon the variation in the belt tension, the movement of the moving member makes the stationary member side plate and the moving member side plate rotate relatively in the fluid chamber between the stationary member and the moving member. Concomitantly with the relative movement of the plates, the magnetorheological fluid in the fluid chamber receives a shear resistance (viscous drag), whereby the rotation of the moving member is suppressed by the shear resistance of the magnetorheological fluid. The magnetic force application device applies the magnetic force to the magnetorheological fluid in the fluid chamber, thereby changing the viscosity of the magnetic viscosity fluid to vary the damping force. Also in this case, a preferable vibration suppression mechanism using the magnetorheological fluid is obtained.

The above-described vibration suppression mechanism may constitute a damping means for damping the vibration of the moving member. By so doing, the vibration suppression mechanism may also function as the damping means.

As described above, according to the invention of claim 1, in the autotensioner which automatically controls the belt tension in the belt drive system for the multicylinder engine configured to suspend cylinder operation, there are provided the vibration suppression mechanism which suppresses the vibration of the moving member by means of the viscous drag of the magnetorheological fluid and the magnetic force application device which applies a magnetic force to the magnetorheological fluid in the vibration suppression mechanism. Accordingly, when a control signal is given when the number of the working cylinders is changed, the magnetic force application device is controlled in response to the control signal such that the magnetic force is applied to the magnetorheological fluid in the vibration suppression mechanism, thereby suppressing the vibration of the moving member. Thus, the magnetic force is applied to the magnetorheological fluid in the vibration suppression mechanism before the output torque of the engine changes suddenly upon the change in the number of the working cylinders, thereby increasing the viscous drag of the magnetorheological fluid to suppress the vibration of the moving member or the belt span. In this way, excessive vibration of the belt and the moving member derived from the suspension of the cylinders is surely prevented from occurring, thereby eliminating a slip of the belt and the occurrence of an unusual noise such as clatter and improving the belt life.

According to the invention of claim 2, when the operation of many cylinders is suspended simultaneously to cause significant variation in the output torque of the engine significantly, the viscous drag of the magnetorheological fluid in the vibration suppression mechanism is raised to suppress the vibration of the moving member. Thereby, the effect of the invention according to claim 1 becomes more significant.

According to the invention of claim 3, the magnetic force is applied to the magnetorheological fluid in the vibration suppression mechanism in synchronization with the change in the number of the working cylinders. Accordingly, the vibration of the moving member is suppressed at optimum timing without being ahead or behind of the variation in the output torque of the engine. Thereby, the effect of the invention according to claim 1 becomes more significant.

### BRIEF DESCRIPTION OF THE DRAWINGS

FIG. 1 is a flowchart illustrating a signal processing procedure performed by a controller for the control of an autotensioner in Embodiment 1 of the present invention.

FIG. 2 is a front view illustrating the whole configuration of an auxiliary drive system for an engine according to Embodiment 1 of the present invention.

FIG. 3 is a sectional view schematically illustrating a damper in an autotensioner.

FIG. 4 is a view illustrating a vibration model of the damper.

FIG. 5 is an oblique view illustrating the whole of the autotensioner.

FIGS. 6A, 6B and 6C are graphs illustrating the characteristics of the damper which suppresses the vibration of the tensioner in response to a change in the number of working cylinders in the engine.

FIG. 7 is a sectional view illustrating an autotensioner according to Embodiment 2.

FIG. 8 is a front view illustrating the autotensioner according to Embodiment 2.

### DETAILED DESCRIPTION OF THE INVENTION

Hereinafter, a detailed explanation is given of embodiments of the present invention with reference to the drawings. The following preferable embodiments are inherently given for explanation only and do not limit the present invention, subjects to which the present invention is applied or the applicable scope of the present invention.

### EMBODIMENT 1

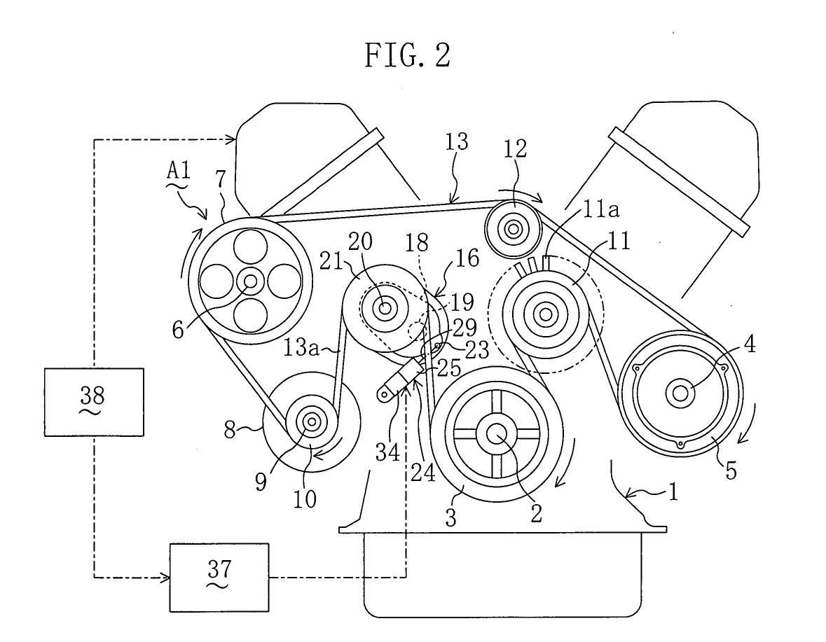

FIG. 2 illustrates an engine auxiliary drive system A1 as a belt drive system according to Embodiment 1 of the present invention. The auxiliary drive system A1 includes: a V-type multicylinder engine 1 installed in a vehicle; a crank pulley 3 fixed co-rotatably to a crank shaft 2 of the engine 1; a compressor pulley 5 fixed co-rotatably to a rotation shaft 4 of a compressor of an air-conditioning equipment as an auxiliary (not shown); a PS pump pulley 7 fixed co-rotatably to a rotation shaft 6 of a power stealing pump as an auxiliary (not shown); an alternator pulley 10 fixed co-rotatably to a rotation shaft 9 of an alternator 8 as an auxiliary; a fan pulley 11 formed integrally with a cooling fan 11a to drive the cooling fan 11a to rotate; and an idler pulley 12.

The crank pulley 3, compressor pulley 5, PS pump pulley 7, alternator pulley 10 and idler pulley 12 are V-ribbed pulleys and the fan pulley 11 is a flat pulley. A drive belt 13 which is a V-ribbed belt is wrapped around the pulleys 3, 5, 7, 10-12. The belt 13 is wrapped around the V-ribbed pulleys 3, 5, 7, 10 and 12 with its inner face (bottom face) contacting thereon. On the fan pulley 11 which is flat, the belt 13 runs with its outer face (back face) contacting thereon. That is, the belt 13 is wrapped around the pulleys in a so-called serpentine layout. With the rotation of the crank shaft 2 (crank pulley 3) associated with the operation of the engine 1, the belt 13 travels in the clockwise direction in FIG. 2 from the crank pulley 3 through the alternator pulley 10, PS pump pulley 7, idler pulley 12, compressor pulley 5, fan pulley 11 and then back to the crank pulley 3, thereby driving the auxiliaries.

In a slack-side span 13a of the belt 13 traveling from the crank pulley 3, more specifically, in the span 13a between the crank pulley 3 and the alternator pulley 10, an arm-type hydraulic autotensioner 16 is arranged to automatically adjust the tension of the belt 13 by pressing the span 13a from the outer face (flat face) of the belt 13.

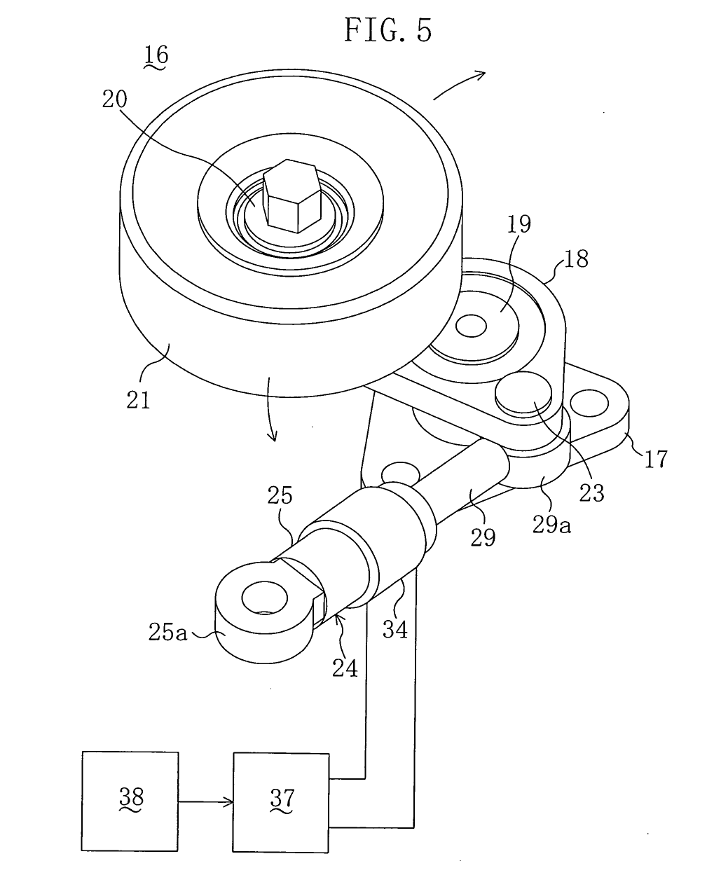

FIG. 5 is an enlarged view illustrating a configuration of the autotensioner 16. Reference numeral 17 indicates a mount to be fixed to the side wall of the engine 1. In this embodiment, the mount 17 and the engine 1 constitute a stationary member. On the mount 17, an arm 18 serving as a moving member is swingably (rotatably) supported at its proximal end to a support shaft 19. A pulley shaft 20 parallel to the support shaft 19 is provided at a distal end of the arm 18 to extend therefrom and a tension pulley 21 which is a flat pulley is rotatably supported on the pulley shaft 20 via a bearing (not shown). The drive belt 13 is wrapped around the tension pulley 21 with the outer face (flat face) thereof contacting the tension pulley 21, such that the belt 13 is pressed by the tension pulley 21.

At the proximal end of the arm 18, an end of a hydraulic damper 24 which constitutes a vibration suppression mechanism is swingably connected via a connection pin 23 at a position offset from the support shaft 19. The other end of the damper 24 is swingably connected to the side wall of the engine 1 (part of the stationary member). Thus, the damper 24 is arranged to suppress the vibration (swing motion) of the arm 18.

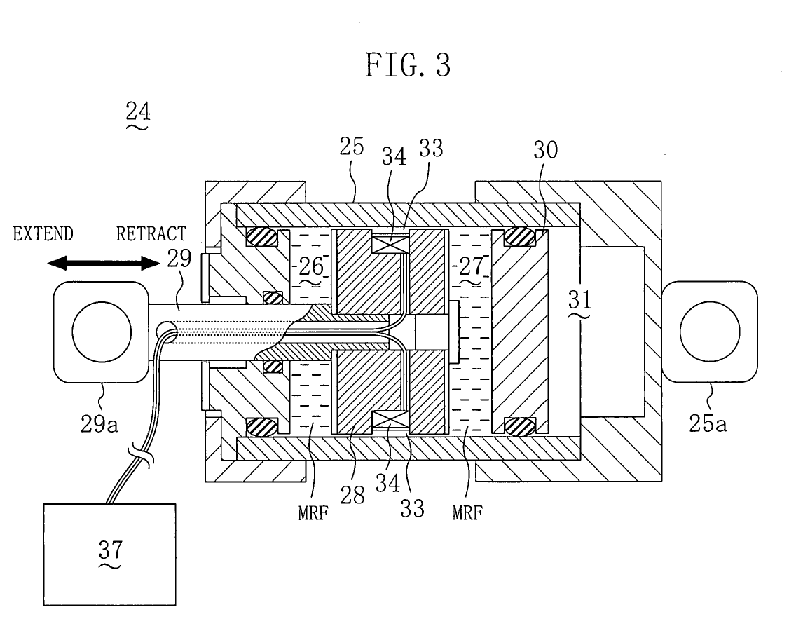

As shown in FIG. 3, the damper 24 suppresses the vibration of the arm 18 (moving member) by means of the viscous drag of a magnetorheological fluid (MRF) made by dispersing an extra-fine ferromagnetic material in liquid. That is, the damper 24 includes a cylinder body 25 having a connecting part 25a for swingably connecting the damper 24 to the engine 1. In the cylinder body 25, a free piston 30 is fitted such that it reciprocates linearly along a cylinder axis. Further, a piston 28 is reciprocatably inserted in the cylinder body 25. The piston 28 divides one of internal cavities divided by the free piston 30 (cavity on the left side in FIG. 3) into a first chamber 26 and a second chamber 27. The first and second chambers 26 and 27 are filled with the MRF.

A proximal end of the rod 29 is integrally fixed to the piston 28. The other end of the rod 29 penetrates the end wall of the cylinder body 25 close to the first chamber 26 in a fluid-tight manner. The movement of the piston 28 allows the rod 29 to extend out of and retract into the cylinder body 25. At the distal end of the rod 29, a connecting part 29a is formed for connection with the proximal end of the arm 18 via the connecting pin 23.

Another internal cavity in the cylinder body 25 divided by the free piston 30 (a cavity on the right side of the free piston 30 in FIG. 3) is filled with high pressure nitrogen gas, for example. The gas is an air spring 31 as a biasing means and biases the piston 28 toward the first chamber 26 via the free piston 30 (the protruding direction of the rod 29). That is, the damper 24 includes the air spring 31, with which the arm 18 is rotatably biased to make the tension pulley 21 press the belt 13.

There is a specified clearance between the inner periphery of the cylinder body 25 and the outer periphery of the piston 28. The clearance forms a communication path 33 communicating with both of the first and second chambers 26 and 27. When the tension of the belt 13 varies to vibrate the tension pulley 21 and the arm 18 supporting the tension pulley 21, the vibration of the arm 18 makes the piston 28 reciprocate in the cylinder body 25, thereby moving the MRF to and from the first and second chambers 26 and 27 via the communication path 33. Thus, the vibration of the arm 18 is suppressed by the flow resistance (viscous drag) of the MRF passing through the communication path 33.

The piston 28 is further provided with an electromagnet 34 as a magnetic force application device which applies a magnetic force to the MRF. When the electromagnet 34 is excited by current application, the magnetic force is applied to the MRF in the communication path 33 between the cylinder body 25 and the piston 28. The magnetic force applied to the MRF can be varied by controlling the output to the electromagnet 34, thereby varying a damping factor to the arm 18. That is, as also shown in FIGS. 2 and 5, the electromagnet 34 is switched between the excited state and the demagnetized state, or alternatively, the magnetic force thereof in the excited state is varied, depending on the current supply from a current supply control section of a controller 37. The controller 37 is configured to receive an output signal from an engine controller 38 which controls the operation of the engine 1.

More specifically, the engine 1 of this embodiment is a V-type multicylinder engine including two banks. While the engine is running, the engine controller 38 controls a fuel injector and an igniter under the specified conditions to stop the fuel supply to some or all cylinders in one bank and the ignition therein. Then, the cylinders enter an idling state in which they do not contribute to the output of the engine 1. When fuel supply to the idling cylinders and ignition therein are restarted, the idling cylinders come into play again. When the number of the working cylinders is changed, the engine controller 38 sends a signal to the controller 37 of the autotensioner 16.

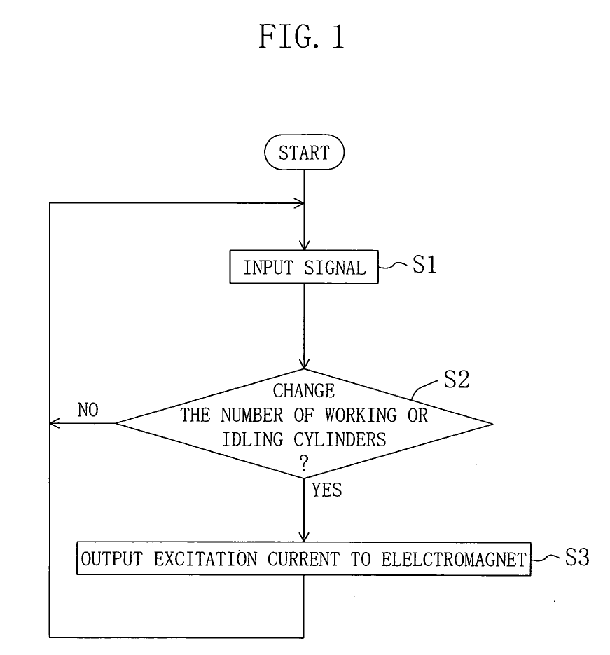

Referring to FIG. 1, an explanation is given of a signal processing procedure performed by the controller 37 for the control of the autotensioner 16. In the first step S1, a signal from the engine controller 38 is input. Then, based on the signal, a judgment is made in step S2 as to whether the number of the working cylinders or the idling cylinders in the engine 1 is varied or not. If the judgment result is NO and the number of the working cylinders is not varied, the procedure returns to step S1. On the other hand, when the judgment result is YES and the number of the working cylinders needs to be changed, the procedure goes to step S3.

In step S3, the electromagnet 34 is supplied with electric power (voltage, current) which is previously specified in a map or the like in correspondence with the number of the working cylinders or idling cylinders to be changed at a timing which is also specified previously in a map or the like, such that the magnetic force is applied to the MRF in the damper 24 in synchronization with the change in the number of the working cylinders. Thus, the electromagnet 34 is excited to give the magnetic force to the MRF in the communication path 33 between the cylinder body 25 and the piston 28, whereby the damping factor to the arm 18 can be varied.

That is, when the number of the working cylinders in the engine 1 is changed, the electromagnet 34 is controlled such that the magnetic force is temporarily applied to the MRF in the damper 24 to suppress the vibration of the arm 18. On the other hand, in the normal operation state where the change in the number of the working cylinders is unnecessary, the electromagnet 34 is not controlled in the above manner.

According to this embodiment, the controller 38 constitutes a cylinder suspension controller which suspends the operation of some cylinders of the engine 1 by at least halting the fuel supply to the cylinders while the engine 1 is running. Further, the controller 37 of the autotensioner 16 constitutes a magnetic force controller which controls the electromagnet 34 such that the magnetic force is applied to the MRF in the damper 24 in response to the signal from the engine controller 38 which is given when the operation of the cylinders is suspended or the suspended cylinders are operated again, thereby suppressing the vibration of the arm 18.

In this embodiment, the piston 28 of the damper 24 is connected to the arm 18 of the autotensioner 16 via the rod 29. Due to the biasing force of the air spring 31 in the cylinder body 25, the piston 28 is biased to extend out of the cylinder body 25. Therefore, while the auxiliaries (compressor for air-conditioning equipment, power stealing pump, alternator 8 and fan 11a) are driven by the auxiliary drive system A1 during the operation of the engine 1, the air spring 31 in the damper 24 biases the arm 18 to rotate. Due to the biasing force, the tension pulley 21 at the distal end of the arm 18 presses the span 13a of the belt 13, giving tension to the belt 13.

Then, when the arm 18 vibrates about the support shaft 19 together with the tension pulley 21 in response to a change in the tension of the belt 13, the piston 28 connected to the arm 18 reciprocates in the cylinder body 25. Concomitantly with the reciprocation of the piston 28, the MRF moves to and from the chambers 26 and 27 in the cylinder body 25 via the communication path 33, whereby the vibration of the arm 18 is suppressed by flow resistance (viscous drag) of the MRF passing through the communication path 33.

Further, when the electromagnet 34 provided at the piston 28 of the damper 24 is excited by current application from the controller 37, the magnetic force is applied to the MRF in the communication path 33. When the magnetic force is varied, the flow resistance of the MRF is varied to change the damping force. Thus, the damping factor to the arm 18 can be varied by controlling the magnetic force to be applied to the MRF.

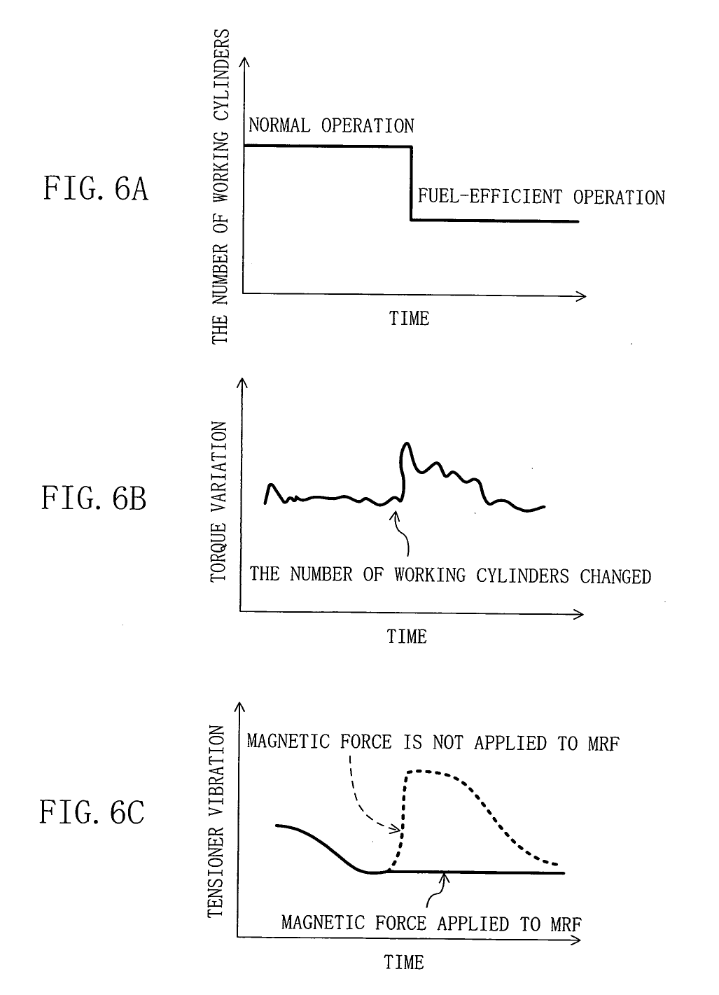

More specifically, when the cylinders in one of the banks shift to the idling state from the normal operation state where every cylinder of the engine 1 is working, i.e., the number of the working cylinders is reduced to the half to enter a fuel-efficient operation state as shown in FIG. 6A, the output torque of the engine varies significantly at that moment as shown in FIG. 6B due to the change in the number of the working cylinders. At this time, when a magnetic force is not applied to the MRF in the damper 24 and the damping force is relatively low, the vibration of the arm 18 of the autotensioner 16 exceeds a specified level to cause significant vibration of the tensioner as indicated by a broken line in FIG. 6C. In this embodiment, however, the controller 37 previously outputs an excitation signal (supplies electric power) to the electromagnet 34 in response to the suspension of the cylinders to excite the electromagnet 34. Therefore, the excited electromagnet 34 applies the magnetic force to the MRF in the damper 24 to increase the viscous drag of the MRF, thereby suppressing the vibration of the arm 18 as indicated by a solid line in FIG. 6C.

That is, if the electromagnet 34 is controlled such that the magnetic force is applied to the MRF in the damper 24 in synchronization with the change in the number of the working cylinders in the engine 1, the damper 24 exerts a suitable damping force (braking force) at optimum timing without being ahead or behind of the variation in the engine output torque caused by the change in the number of the working cylinders. This allows suppressing the vibration of the belt 13 and the arm 18 of the autotensioner 16 and avoiding leap of these components. Thus, a slip of the belt 13 and the occurrence of an unusual noise such as clatter are surely prevented, and moreover, the belt life is prolonged.

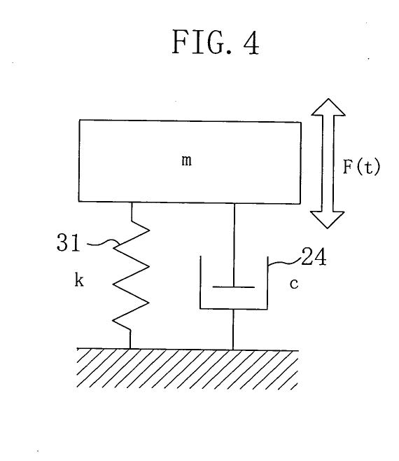

The damper 24 according to the above embodiment can be regarded as a vibration model shown in FIG. 4 and represented by the following equation.
m(dx/dt)²+c(dx/dt)+kx=F(t)

In the above equation, m is a mass of the moving member, k is a spring modulus, c is a viscous damping factor and F (t) is a tension of the belt 13.

In this case, the viscous damping factor c can optionally be varied with use of the MRF. Therefore, the damping force is chronologically adjusted to the optimum with respect to the belt tension F (t) which is an output. Further, a constant damping force is obtained by decreasing or increasing the viscosity of the MRF when the piston speed is high or low, respectively. Therefore, need of considering the dependence of the damping force on the piston speed is eliminated. In other words, the damping force is obtained with optional dependence on the piston speed.

In the above embodiment, the communication path 33 communicating with the chambers 26 and 27 in the cylinder body 25 is provided between the inner periphery of the cylinder body 25 and the outer periphery of the piston 28. However, for example, the communication path may be formed in the piston 28 or in the wall of the cylinder body 25.

In the above embodiment, the electromagnet 34 is provided at the piston 28. However, the electromagnet 34 may be provided at the cylinder body 25.

In the above embodiment, the present invention is applied to the arm-type hydraulic autotensioner 16, but the invention may also be applied to a rod-type hydraulic autotensioner. Though not shown, the rod-type hydraulic autotensioner includes a rod member which is supported on a side wall of an engine 1 (stationary member) to be slidable in the axis direction, a tension pulley which is rotatably supported on the distal end of the rod member and a hydraulic damper which is connected to the rod member to damp the sliding movement of the rod member. The hydraulic damper is similar to that described in Embodiment 1. In the rod-type hydraulic autotensioner, one of the cylinder body and the rod of the hydraulic damper may serve as the rod member and the other may constitute the stationary member. By so doing, the autotensioner can be reduced in size.

Further, in the above embodiment, the magnetic force of the electromagnet 34 may be controlled by the controller 37 such that the movement of the arm 18 is locked. By so doing, the vibration of the arm 18 and the belt span 13a is surely avoided. Therefore, the vibration of the belt 13 and the arm 18 caused by the change in the number of working cylinders is prevented effectively.

### EMBODIMENT 2

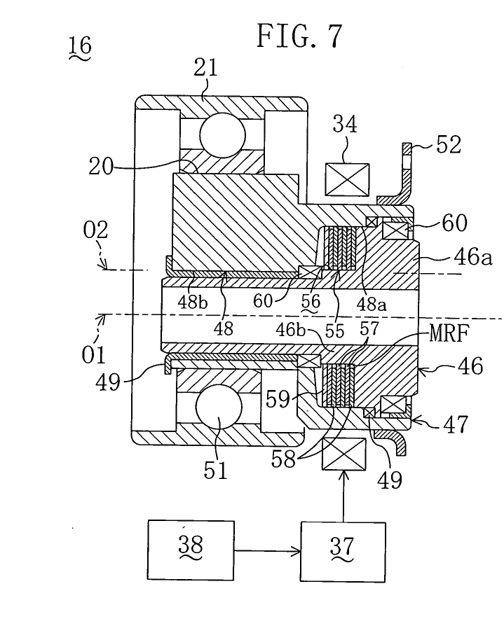

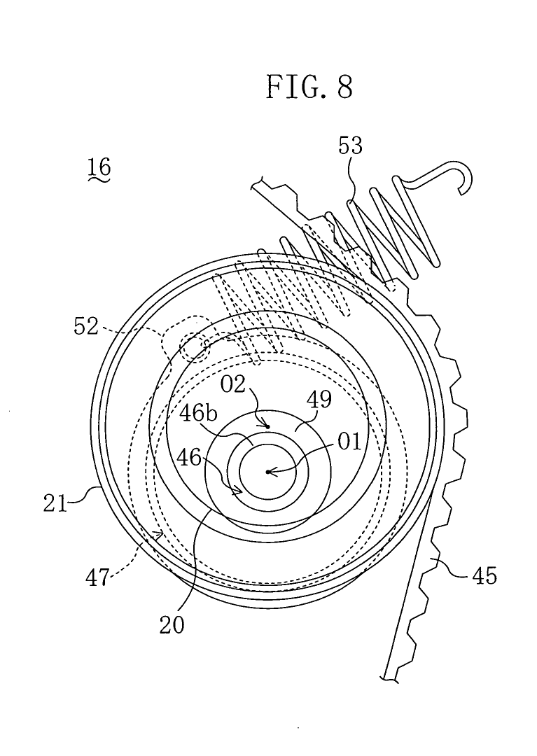

FIGS. 7 and 8 show Embodiment 2 of the present invention. In the above embodiment, the auxiliary drive system A1 is regarded as the belt drive system and the present invention is applied to the autotensioner 16 including the hydraulic damper 24. In this embodiment, however, a valve operating system for the engine 1 is regarded as the belt drive system and the present invention is applied to an autotensioner 16 including a viscous damper (multiplate viscous damper).

Though not shown, this embodiment relates to, for example, a valve operating system for driving a cam shaft for driving an intake/exhaust valve in synchronization with the rotation of a crank shaft 2 of the engine 1 with use of a timing belt 45 which is a cogged belt (see FIG. 8). The viscous autotensioner 16 is used for automatic adjustment of the tension of the timing belt 45.

In FIGS. 7 and 8, reference numeral 46 indicates a fixed hollow cylindrical shaft having a large diameter part 46a closer to the proximal end thereof (right end in FIG. 7) and a small diameter part 46b closer to the distal end thereof (left end in FIG. 7). A mounting bolt (not shown) is inserted into the shaft 46 and screwed to fix the distal end of the shaft 46 unrotatably to the engine 1. In this embodiment, the fixed shaft 46 and the engine 1 constitute a stationary member.

On the fixed shaft 46, a stepped cylindrical sleeve 47 is swingably (rotatably) supported as a moving member. The sleeve 47 includes a center hole 48 having a large diameter hole 48a in which the large diameter part 46a of the fixed shaft 46 is fitted and a small diameter hole 48b in which the small diameter part 46b is fitted. The shaft 46 is fitted in the center hole 48 from the distal end via ball bearings 49 (slide bearings may also be used), whereby the sleeve 47 is supported on the fixed shaft 46 to be swingable about a shaft axis O1.

At the distal end of the sleeve 47, a pulley shaft 20 having a center axis O2 offset from the center hole 48 (the axis O1 of the fixed shaft 46) is integrally formed. A tension pulley 21 is rotatably supported on the pulley shaft 20 via a bearing 51 (an outer race thereof serves as the tension pulley 21).

A spring holder 52 is fitted on the outer periphery of the proximal end of the sleeve 47 in a co-rotatable manner. Further, as shown in FIG. 8, one of the ends of a tension spring 53 serving as a biasing means is engaged to the spring holder 52. The other end of the tension spring 53 is engaged to the engine 1. With the tension spring 53, the sleeve 47 is biased to rotate in the clockwise direction in FIG. 8, whereby the tension pulley 21 on the pulley shaft 20 presses the outer surface of the span of the timing belt 45.

As shown in FIG. 7, a viscous damper 55 is arranged between the fixed shaft 46 and the sleeve 47. The damper 55 includes an annular fluid chamber 56 arranged coaxially with the rotational axis of the sleeve 47 (the axis O1 of the fixed shaft 46). The fluid chamber 56 is surrounded by the front plane of the large diameter part 46a of the fixed shaft 46, the outer periphery of the small diameter part 46b closer to the large diameter part 46a, the inner circumference plane of the large diameter hole 48a of the center hole 48 of the sleeve 47 closer to the small diameter hole 48b and the flat plane of the step between the large diameter hole 48a and the small diameter hole 48b. The fluid chamber 56 is filled with the MRF.

In the fluid chamber 56, a plurality of inner plates 57 (plates toward the stationary member) are engaged co-rotatably to the outer circumference plane of the small diameter part 46b of the fixed shaft 46 and a plurality of outer plates 58 (plates toward the moving member) are engaged co-rotatably to the inner circumference plane of the large diameter hole 48a of the sleeve 47. The plates 57 and 58 are alternately arranged with the interposition of spacers (not shown) along the rotation axis direction of the sleeve 47 (at least one plate 57 and one plate 58 are necessary). When the sleeve 47 rotates about the fixed shaft 46 together with the tension pulley 21 in response to a variation in the tension of the belt 45, each of the outer plates 58 moves relatively to each of the inner plates 57 in the fluid chamber 56 between the fixed shaft 46 and the sleeve 47. Thus, the rotation of the sleeve 47 is damped by making use of shear resistance (viscous drag) of the MRF in the fluid chamber 56 caused by the relative rotation of the plates 57 and 58. In FIG. 7, reference numeral 59 is a fixed plate arranged on the distal end side of the fluid chamber 56 and 60 is a sealing member for hermetically sealing the fluid chamber 56.

An electromagnet 34 is arranged around the proximal end of the sleeve 47. The excitation of the electromagnet 34 applies a magnetic force to the MRF in the fluid chamber 56. The electromagnet 34 may be buried in the fixed shaft 46 or the sleeve 47 as long as the magnetic force is applied to the MRF in the fluid chamber 56. Other configuration than the above is the same as that of Embodiment 1.

Thus, in this embodiment, the tension spring 53 is connected to the sleeve 47 of the autotensioner 16 and the sleeve 47 is biased to rotate by the biasing force of the tension spring 53. Therefore, the tension pulley 21 on the sleeve 47 presses the timing belt 45 while the engine 1 is running and the cam shaft is driven by the valve operating system A2 in synchronization with the crank shaft 2.

When the sleeve 47 rotates about the fixed shaft 46 together with the tension pulley 21 in response to the variation in the tension of the belt 45, the rotation of the sleeve 47 makes the outer plates 58, which are engaged co-rotatably to the sleeve 47 in the fluid chamber 56 between the outer periphery of the fixed shaft 46 and the inner periphery of the center hole 48 of the sleeve 47, rotate relative to the inner plates 57 which are engaged co-rotatably to the fixed shaft 46. Then, concomitantly with the relative rotation of the plates 57 and 58, the MRF in the fluid chamber 56 generates shear resistance (viscous drag) and the rotation of the sleeve 47 is damped by the shear resistance of the MRF.

When the number of the working cylinders in the engine 1 is changed in the same manner as Embodiment 1, the controller 37 outputs an excitation signal to the electromagnet 34 arranged outside the sleeve 47 such that the electromagnet 34 applies a magnetic force to the MRF in the fluid chamber 56. Since the magnetic force is thus changed, the viscosity of the MRF is varied to change the damping force.

Thus, the effect of Embodiment 1 is also obtained in this embodiment. Since the MRF is used in the damper 55 of the viscous autotensioner 16, even a sudden variation in the tension of the timing belt 45 is absorbed in every part of the belt without deteriorating the damping characteristic.

As the damper for the autotensioner 16, the hydraulic damper 24 is used in Embodiment 1 and the viscous damper 55 (multiplate viscous damper) is used in Embodiment 2. However, a damper of other configuration may be used and the MRF may be used to fill it. An example of the other employable dampers has been proposed by Japanese Unexamined Patent Publication No. 2003-090398.

As the biasing means, the air spring 31 is used in Embodiment 1 and the tension spring 53 is used in Embodiment 2. The biasing means of the present invention may include various biasing means of any configurations such as metal springs of various configurations and hydraulic cylinders making use of engine oil.

In the above embodiments, the dampers 24 and 55 function as the vibration suppression mechanism. However, another vibration suppression mechanism may be added independently from the dampers.

Further, in the above embodiments, the present invention is applied to the auxiliary drive system A1 and the valve operating system A2 for the multicylinder engine 1. However, the present invention is also applicable to the autotensioners used for other belt drive systems for the multicylinder engine 1.

1. An autotensioner used in a belt drive system for a multicylinder engine provided with a cylinder suspension controller which suspends the operation of some cylinders in the engine in operation, the autotensioner comprising:
a moving member which is movably supported on a stationary member;
a tension pulley which is rotatably supported on the moving member and around which a belt is wrapped;
a biasing means for biasing the moving member such that the tension pulley presses the belt;
a vibration suppression mechanism which damps the vibration of the moving member by means of the viscous drag of a magnetorheological fluid; and
a magnetic force application device which applies a magnetic force to the magnetorheological fluid in the vibration suppression mechanism, wherein
the autotensioner is configured to automatically adjust the tension of the belt and, when variation in the belt tension is more significant than specified, to allow the magnetic force application device to apply the magnetic force to the magnetorheological fluid in the vibration suppression mechanism to increase the damping force of the vibration suppression mechanism due to the viscous drag on the moving member, and
the autotensioner further comprises a magnetic force controller which controls the magnetic force application device such that the magnetic force is applied to the magnetorheological fluid in the vibration suppression mechanism in response to a signal from the cylinder suspension controller which is given when the operation of the cylinders is suspended or the operation of the suspended cylinders is restarted by the cylinder suspension controller.

2. An autotensioner according to claim 1, wherein
the magnetic force controller controls the magnetic force application device when the operation of the multicylinder engine is shifted from a full cylinder operation mode in which all of the cylinders are working to a partial cylinder operation mode in which not less than one third thereof are suspended from working.

3. An autotensioner according to claim 1, wherein
the magnetic force controller controls the magnetic force application device such that the magnetic force is applied to the magnetorheological fluid in the vibration suppression mechanism in synchronization with the change in the number of the working cylinders.
